(19) United States
(12) Patent Application Publication
(10) Pub. No.: US 2024/0372418 A1
(43) Pub. Date: Nov. 7, 2024

(54) WIRELESS CHARGING METHOD AND APPARATUS, AND ELECTRONIC DEVICE

(71) Applicant: VIVO MOBILE COMMUNICATION CO., LTD., Dongguan (CN)

(72) Inventors: Yun ZHAO, Dongguan (CN); Yong HAN, Dongguan (CN)

(73) Assignee: VIVO MOBILE COMMUNICATION CO., LTD., Dongguan (CN)

(21) Appl. No.: 18/773,745

(22) Filed: Jul. 16, 2024

Related U.S. Application Data
(63) Continuation of application No. PCT/CN2023/071477, filed on Jan. 10, 2023.

(30) Foreign Application Priority Data
Jan. 17, 2022 (CN) 202210050144.2

(51) Int. Cl. H02J 50/90; H02J 50/23

(52) U.S. Cl. CPC H02J 50/90; H02J 50/23

(57) ABSTRACT

A wireless charging method, and an electronic device, are provides. The wireless charging method is performed by a wireless charging apparatus. The wireless charging apparatus includes a monopulse antenna array. The method includes: controlling, in a preset tracking period, the monopulse antenna array to transmit a sum beam and a difference beam to a to-be-charged device, and receiving an echo signal reflected from the to-be-charged device. The preset tracking period is a period that the monopulse antenna array transmits the sum beam and the difference beam. The method further includes tracking a position of the to-be-charged device based on the echo signal. The method also includes controlling, based on position information of the to-be-charged device, the monopulse antenna array to wirelessly charge the to-be-charged device.

### CROSS-REFERENCE TO RELATED APPLICATIONS

This application is a continuation of International Application No. PCT/CN2023/071477, filed on Jan. 10, 2023, which claims priority to Chinese Patent Application No. 202210050144.2, filed in China on Jan. 17, 2022. The entire contents of each of the above-referenced applications are expressly incorporated herein by reference.

### TECHNICAL FIELD

This application belongs to the field of wireless charging technologies, and specifically, relates to a wireless charging method and apparatus, and an electronic device.

### BACKGROUND

Currently, a device such as a mobile phone or an earphone supporting a wireless charging function is wirelessly charged basically in an electromagnetic induction manner. Both a charger and a charged device need to be equipped with coils. When charging is performed, the coils of the charger and the charged device need to be aligned, and charging may be performed normally only when a distance between the charger and the charged device is extremely close. In addition, a position of the charged device needs to remain unchanged. Because of many restrictions of wireless charging, a user generally cannot charge a mobile phone wirelessly while holding and using the mobile phone.

### SUMMARY

An objective of embodiments of this application is to provide a wireless charging method and apparatus, and an electronic device.

According to a first aspect, embodiments of this application provide a wireless charging method, applied to a wireless charging apparatus. The wireless charging apparatus includes a monopulse antenna array, and the method includes:
controlling, in a preset tracking period, the monopulse antenna array to transmit a sum beam and a difference beam to a to-be-charged device, and receiving an echo signal reflected from the to-be-charged device, where the preset tracking period is a period that the monopulse antenna array transmits the sum beam and the difference beam;
tracking a position of the to-be-charged device based on the echo signal; and
controlling, based on position information of the to-be-charged device, the monopulse antenna array to wirelessly charge the to-be-charged device.

According to a second aspect, embodiments of this application provide a wireless charging apparatus. The wireless charging apparatus includes a monopulse antenna array, and the wireless charging apparatus includes:
a transceiver module, configured to: control, in a preset tracking period, the monopulse antenna array to transmit a sum beam and a difference beam to a to-be-charged device, and receive an echo signal reflected from the to-be-charged device, wherein the preset tracking period is a period that the monopulse antenna array transmits the sum beam and the difference beam;
a tracking module, configured to track a position of the to-be-charged device based on the echo signal; and
a charging module, configured to: control, based on position information of the to-be-charged device, the monopulse antenna array to wirelessly charge the to-be-charged device.

According to a third aspect, embodiments of this application provide an electronic device, where the electronic device includes a processor and a memory. The memory stores a program or instructions executable on the processor. When the program or the instructions are executed by the processor, steps of the method according to the first aspect are implemented.

According to a fourth aspect, embodiments of this application provide a readable storage medium, where the readable storage medium stores a program or instructions, and when the program or the instructions are executed by a processor, the steps of the method according to the first aspect are implemented.

According to a fifth aspect, embodiments of this application provide a chip, where the chip includes a processor and a communication interface, the communication interface is coupled to the processor, and the processor is configured to run a program or instructions to implement the method according to the first aspect.

According to a sixth aspect, embodiments of this application provide a computer program product, where the computer program product is stored in a storage medium, and the program product is executed by at least one processor to implement the method according to the first aspect.

In embodiments of this application, a position of a to-be-charged device is tracked by using a monopulse antenna array in a preset tracking period. Therefore, power and/or a phase of the monopulse antenna array may be controlled based on the position of the to-be-charged device to wirelessly charge the to-be-charged device. A plurality of restrictions on the position, a distance, and the like of the to-be-charged device in an existing wireless charging technology are removed, and a wireless charging need of the to-be-charged device at a remote distance and in a moving scenario may be effectively satisfied.

### BRIEF DESCRIPTION OF THE DRAWINGS

FIG. 1 is a schematic flowchart of a wireless charging method according to an embodiment of this application;

FIG. 2 is a schematic diagram of a sum direction diagram and a difference direction diagram according to an embodiment of this application;

FIG. 3 is a schematic diagram of changes of a sum direction diagram and a difference direction diagram when a to-be-charged device moves according to an embodiment of this application;

FIG. 4 is a schematic diagram of a structure of a wireless charging apparatus according to an embodiment of this application;

FIG. 5 is a schematic diagram of an antenna array according to an embodiment of this application;

FIG. 6 is a beam control principle diagram an antenna array according to an embodiment of this application;

FIG. 7 is a schematic diagram of a structure of another wireless charging apparatus according to an embodiment of this application;

FIG. 8 is a schematic diagram of a structure of an electronic device according to an embodiment of this application; and

FIG. 9 is a schematic hardware diagram a structure of an electronic device for implementing an embodiment of this application.

### DETAILED DESCRIPTION

The following clearly describes the technical solutions in embodiments of this application with reference to the accompanying drawings in embodiments of this application. It is clear that, the described embodiments are some of embodiments of this application rather than all of the embodiments. All other embodiments obtained by a person of ordinary skill in the art based on embodiments of this application shall fall within the protection scope of this application.

The terms “first”, “second”, and the like in the specification and claims of this application are used to distinguish between similar objects, but are not used to describe a specific sequence or order. It may be understood that the data used in such a way are interchangeable in proper circumstances, so that the embodiments of this application can be implemented in sequences other than the sequence illustrated or described herein. Objects distinguished by using “first” and “second” are generally of one class, and a quantity of the objects are not limited. For example, there may be one or more first objects. In addition, “and/or” in the specification and the claims represents at least one of connected objects, and the character “/” generally represents an “or” relationship between associated objects.

With reference to the accompanying drawings, the following provides detailed descriptions of a wireless charging method and apparatus, and an electronic device provided in embodiments of this application by using embodiments and application scenarios.

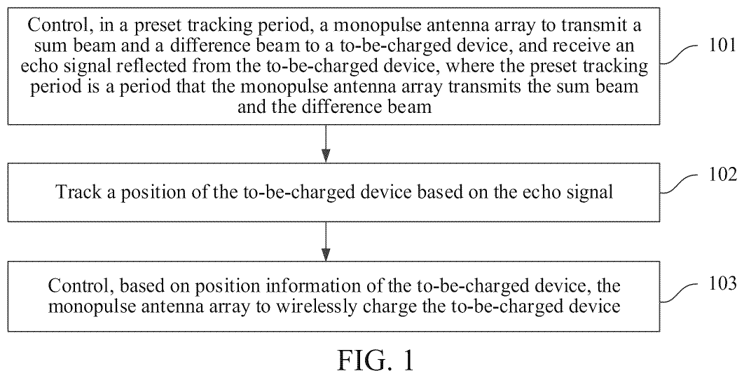

FIG. 1 is a schematic flowchart of a wireless charging method according to an embodiment of this application. As shown in FIG. 1, an aspect of embodiments of this application provides the wireless charging method, and the method is applied to a wireless charging apparatus. The wireless charging apparatus includes a monopulse antenna array, and the method includes the following steps.

Step 101: Control, in a preset tracking period, the monopulse antenna array to transmit a sum beam and a difference beam to a to-be-charged device, and receive an echo signal reflected from the to-be-charged device, where the preset tracking period is a period that the monopulse antenna array transmits the sum beam and the difference beam.

In embodiments of this application, when it is detected that the to-be-charged device is in a wireless charging range of the wireless charging apparatus, the monopulse antenna array is controlled, in the preset tracking period, to transmit the sum beam and the difference beam to the to-be-charged device. The sum beam and the difference beam transmitted by the monopulse antenna array are reflected when encountering the to-be-charged device, and then the echo signal reflected by the to-be-charged device is received.

In embodiments of this application, the wireless charging range may be a spherical range having the wireless charging apparatus as a center and a value as a radius. A size of the radius depends on transmit power of the wireless charging apparatus. Because a requirement on a distance between the wireless charging apparatus and the to-be-charged device in embodiments is not strict, that is, the to-be-charged device only needs to be in the wireless charging range to be wirelessly charged, during wirelessly charging, a user may hold and use the to-be-charged device in a hand, and the to-be-charged device may move randomly in the wireless charging range. This satisfies a wireless charging need of the to-be-charged device at a remote distance and in a moving scenario.

In embodiments of this application, it is considered that the to-be-charged device moves in the wireless charging range of the wireless charging apparatus. Therefore, the position of the to-be-charged device needs to be detected in the preset tracking period, to dynamically adjust the transmit power and a phase of the wireless charging apparatus, and keep the to-be-charged device always in an optimal charging status. The preset tracking period is the period that the monopulse antenna array transmits the sum beam and the difference beam.

Step 102: Track the position of the to-be-charged device based on the echo signal.

In embodiments of this application, for example, the sum beam has a major lobe, and the difference beam has two (or four) major lobes. A function of the sum beam is to detect the distance of the to-be-charged device to implement distance tracking. A function of the difference beam is to detect information about an azimuth angle and a pitch angle of the to-be-charged device to implement angle tracking.

The sum beam and the difference beam are transmitted in each preset tracking period, so that a position of the to-be-charged device in each preset tracking period may be determined based on the received echo signal in each preset tracking period. This continuous detection may implement the tracking of the position of the to-be-charged device.

Step 103: Control, based on position information of the to-be-charged device, the monopulse antenna array to wirelessly charge the to-be-charged device.

In embodiments of this application, for example, the position information of the to-be-charged device includes an azimuth angle and a pitch angle (relative to the monopulse antenna array) of the to-be-charged device, the distance between the to-be-charged device and the monopulse antenna array, and the like. After the position information of the to-be-charged device is obtained, power, a phase, and the like of a charging beam of the monopulse antenna array are dynamically controlled based on the position information of the to-be-charged device to wirelessly charge the to-be-charged device. Therefore, it is ensured that the to-be-charged device may be in the optimal charging status at any position in the wireless charging range.

Therefore, in embodiments of this application, the position of the to-be-charged device is tracked by using the monopulse antenna array in the preset tracking period. Therefore, the power and/or the phase of the monopulse antenna array may be controlled based on the position of the to-be-charged device to wirelessly charge the to-be-charged device. A plurality of restrictions on the position, the distance, and the like of the to-be-charged device in an existing wireless charging technology are removed, and a wireless charging need of the to-be-charged device at the remote distance and in the moving scenario may be effectively satisfied.

In some embodiments of this application, that the echo signal includes a difference signal and a sum signal, and the position of the to-be-charged device is tracked based on the echo signal includes:
adjusting the phase of the monopulse antenna array based on the difference signal, to enable a zero value direction of the difference beam to be aligned with the to-be-charged device.

In other words, the echo signal reflected by the to-be-charged device includes the difference signal, where the difference signal corresponds to the difference beam.

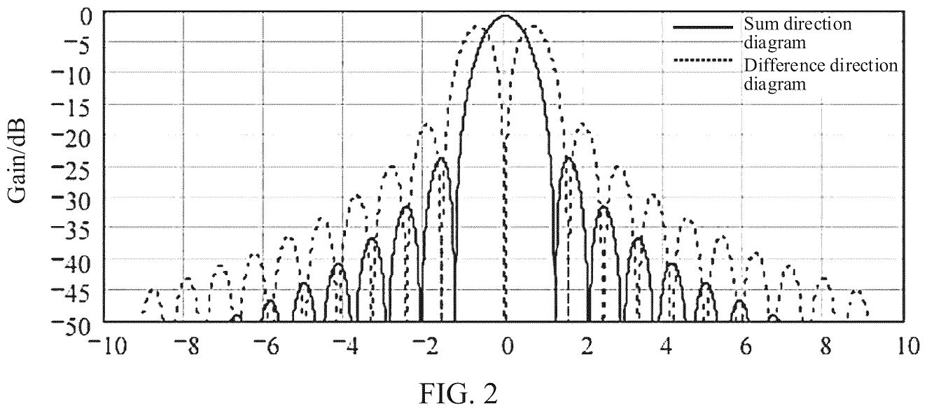

FIG. 2 is a schematic diagram of a sum direction diagram and a difference direction diagram according to an embodiment of this application. If a to-be-charged device is located exactly in a maximum value direction of a sum beam, a received difference signal is minimum (that is, corresponds to a zero value of the difference direction diagram). If the to-be-charged device remains stationary, the received difference signal remains unchanged. When the to-be-charged device moves, the received difference signal changes from weak to strong. For example, if the to-be-charged device moves to the left, a beam signal on a left side of the difference direction diagram increases. If the to-be-charged device moves to the right, a beam signal on a right side of the difference direction diagram increases. Therefore, a moving direction and a moving distance of the to-be-charged device may be determined based on the difference signal, and then a phase of the monopulse antenna array may be adjusted, to enable the zero value direction of the difference beam to be aligned with the to-be-charged device, or to enable the maximum value direction of the sum beam to be aligned with the to-be-charged device. When the sum beam is used as a charging beam, the to-be-charged device may always be located at a maximum radiation direction of the sum beam.

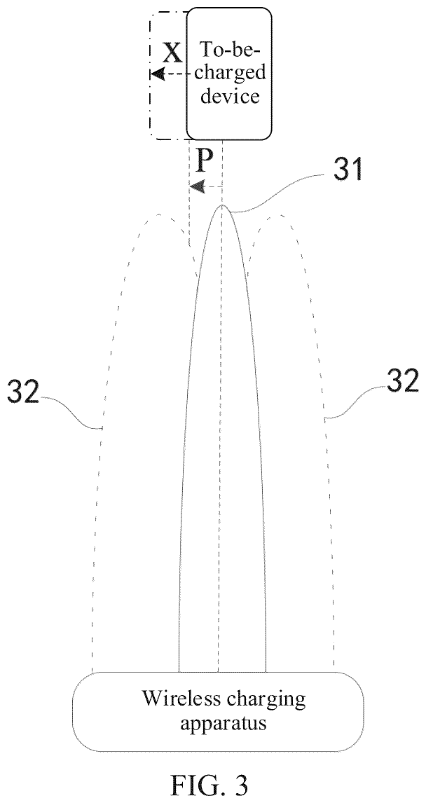

FIG. 3 is a schematic diagram of changes of a sum direction diagram and a difference direction diagram when a to-be-charged device moves according to an embodiment of this application. As shown in FIG. 3, a maximum radiation direction of an original sum direction diagram 31 is aligned with a to-be-charged device, that is, a zero value direction of the difference direction diagram is aligned with the to-be-charged device. When the to-be-charged device is in a moving state, for example, the to-be-charged device moves a distance x to the left, there is a distance P between the maximum radiation direction of the sum direction diagram and the to-be-charged device, and a beam signal on a left side the difference direction diagram 32 increases. On the contrary, if the to-be-charged device moves to the right, the beam signal on a right side of the difference direction diagram 32 increases. Therefore, a moving direction and a moving distance of the to-be-charged device may be determined based on a difference signal.

In some embodiments of this application, a preset tracking period may be adjusted based on a moving speed of the to-be-charged device. For example, if the moving speed of the to-be-charged device is less than a threshold in a time duration, it is considered that the moving speed of the to-be-charged device is slow. Therefore, the preset tracking period may be extended appropriately. However, if the moving speed of the to-be-charged device is greater than a threshold in a time duration, it is considered that the moving speed of the to-be-charged device is fast. Therefore, the preset tracking period may be shortened appropriately, to ensure real-time and accurate tracking.

In some embodiments, if a position change that is of the to-be-charged device and that is detected in two adjacent preset tracking periods is small, for example, a distance change is less than a threshold, a phase of the monopulse antenna array may not be adjusted, to avoid frequent adjustment of the phase of the monopulse antenna array.

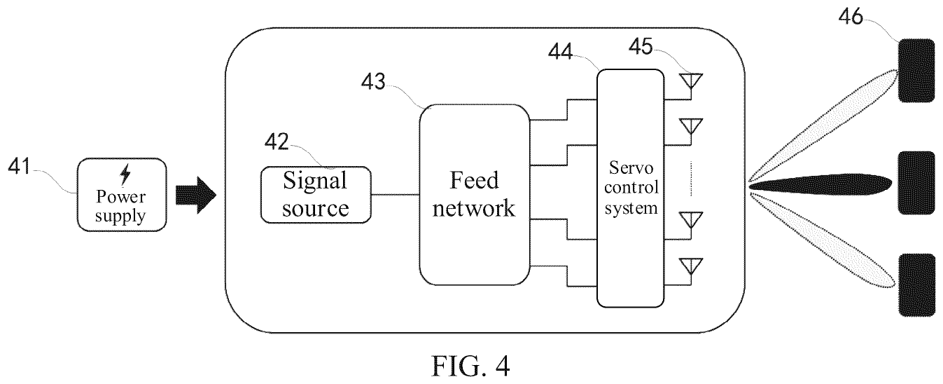

FIG. 4 is a schematic diagram of a structure of a wireless charging apparatus according to an embodiment of this application. As shown in FIG. 4, the wireless charging apparatus includes a power supply 41, a signal source 42, a feed network 43, a servo control system 44, and a monopulse antenna array 45. The power supply 41 provides power for the wireless charging apparatus. The signal source 42 is used to generate a signal. The signal source 42 connects with the monopulse antenna array 45 through the feed network 43 and the servo control system 44. After a phase of a feed signal is adjusted through the feed network, a sum beam and a difference beam may be transmitted simultaneously. When the to-be-charged device 46 moves, a signal received by the difference beam changes from weak to strong. The servo control system is driven by using a difference signal, to rotate the monopulse antenna array 45 in pitch or azimuth, so that the zero value direction of the difference beam is enabled to be always aligned with the to-be-charged device 46. This implements direction tracking of the to-be-charged device 46.

In some embodiments of this application, the wireless charging apparatus has the servo control system for phase control. The servo control system includes an electronically controlled beam controller and a phase shifter. The maximum radiation direction of the monopulse antenna array is changed by changing a phase of each radiation unit in the monopulse antenna array and using a phased array working principle. For example, each radiation unit is followed by the phase shifter to change the corresponding phase of each radiation unit. This changes a phase plane such as an electromagnetic wave of the monopulse antenna array, and implement beam directional radiation.

The following introduces an adjust principle of the maximum radiation direction of the antenna array.

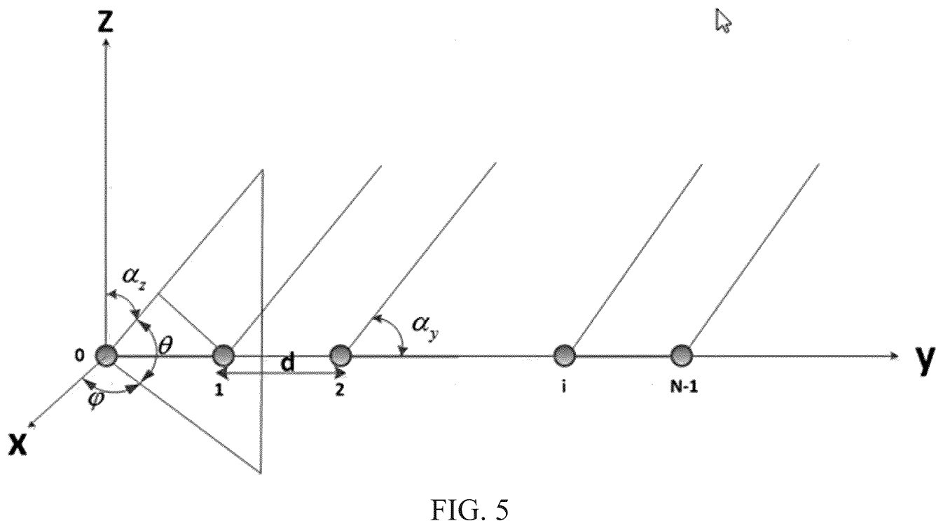

FIG. 5 is a schematic diagram of an antenna array according to an embodiment of this application. As shown in FIG. 5, in a coordinate system composed of an x-axis, a y-axis, and a z-axis, a linear receives an antenna array composed of N antenna units, and isotropic antenna units arranged in a line at an equal interval d. Then, in a θ direction, a phase difference of signals received by adjacent antenna units is

$$∅ = 2 π \frac{d}{λ} sin θ ,$$

an excitation current of each antenna unit is i, and electric field strength radiated by each antenna unit is proportional to the excitation current. It is assumed that an observation point is far from the antenna array, rays from each antenna unit to the observation point may be considered to be parallel to each other. Then total strength at the observation point may be considered as a sum of strengths radiated by the N antenna units in the antenna array. An array factor of a radiation direction diagram may be simplified as:

$$F ( θ ) = {\sum }_{i = 0}^{N - 1} {a}_{i} {e}^{j i ( \frac{2 π}{λ} d s i n θ - Δ {ϕ}_{B} )}$$

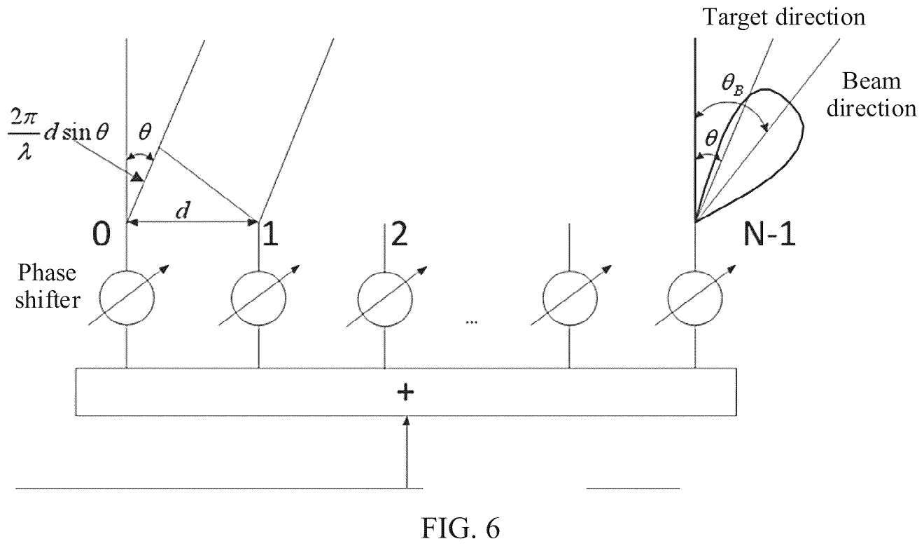

FIG. 6 is a beam control principle diagram an antenna array according to an embodiment of this application. As shown in FIG. 6, an antenna array maximum beam direction θ_{B} may be represented as:

$${θ}_{B} = arcsin ( \frac{λ}{2 π d} Δ {ϕ}_{B} )$$

Δϕ_{B} is a phase difference of adjacent antenna units, λ is a wavelength of a wave radiated by the antenna unit, and d is a distance between the adjacent antenna units.

From the foregoing formula, by changing the phase difference Δϕ_{B} of each antenna unit by using a servo system, the maximum radiation direction θ_{B} of the antenna array may be adjusted.

In some embodiments of this application, that a monopulse antenna array is controlled, based on position information of a to-be-charged device, to wirelessly charge the to-be-charged device includes:
controlling, in a preset tracking period, the monopulse antenna array to transmit an electromagnetic wave at an adjusted phase, to wirelessly charge the to-be-charged device.

In this embodiment, after the position information of the to-be-charged device is obtained in a preset tracking period, and before a next preset tracking period, the monopulse antenna array is controlled to transmit the electromagnetic wave at the adjusted phase, to wirelessly charge the to-be-charged device. Because the phase of the monopulse antenna array is adjusted based on a received difference signal, that is, the adjusted phase of the monopulse antenna array may ensure that a maximum radiation direction of a charging beam is aligned with the to-be-charged device, the electromagnetic wave is transmitted at the adjusted phase by using the monopulse antenna array. This may ensure that even if the to-be-charged device is in a moving state, wireless charging efficiency of the to-be-charged device always be maintained at high efficiency. It may be learned that, for each preset tracking period, the phase of the monopulse antenna array may change, that is, a position of the to-be-charged device changes. Therefore, when the to-be-charged device is charged in any preset tracking period, the to-be-charged device is charged wirelessly based on the adjusted phase in this preset tracking period.

In another some embodiments of this application, that the echo signal further includes a sum signal, and the position of the to-be-charged device is tracked based on the echo signal includes:
determining a distance between the to-be-charged device and the monopulse antenna array based on the sum signal.

In other words, the echo signal reflected by the to-be-charged device further includes a sum signal, where the sum signal corresponds to the sum beam.

As shown in FIG. 2 and FIG. 3, if the to-be-charged device is located exactly in the maximum value direction of the sum beam, the distance between the to-be-charged device and the monopulse antenna array may be detected based on the beam signal at this time. Therefore, this determines a space position of the to-be-charged device. When the to-be-charged device moves, the to-be-charged device may be continuously tracked by using the difference signal.

In some embodiments of this application, that a monopulse antenna array is controlled, based on position information of a to-be-charged device, to wirelessly charge the to-be-charged device further includes:
determining target charging power of the monopulse antenna array in each preset tracking period based on a distance between the monopulse antenna array and the to-be-charged device that is tracked in each preset tracking period; and
controlling, in the preset tracking period, the monopulse antenna array to wirelessly charge the to-be-charged device at the target charging power.

In this embodiment, after the distance between the to-be-charged device and the monopulse antenna array is obtained, charging power may be adjusted based on the distance from the to-be-charged device, to ensure wireless charging efficiency and electromagnetic radiation safety. For example, for the distance between the monopulse antenna array and the to-be-charged device that is tracked in each preset tracking period, corresponding target charging power may be determined. Then, the monopulse antenna array is controlled, in the corresponding preset tracking period, to wireless charge the to-be-charged device at the corresponding target charging power.

In some embodiments, for example, if a difference of the target charging power determined in two adjacent preset tracking periods is less than a first power threshold, charging may be performed both at the target charging power determined in an earlier preset tracking period in the two adjacent preset tracking periods at the two adjacent preset tracking periods. In other words, if the difference of the target charging power determined in the two adjacent preset tracking periods is less than the first power threshold, it is considered that a distance change between the to-be-charged device and the monopulse antenna array is small. Therefore, in the two preset tracking periods, the charging power does not need to be adjusted, and frequent adjustment of the charging power is avoided.

In some embodiments of this application, when the monopulse antenna array is controlled, based on the position information of the to-be-charged device, to wirelessly charge the to-be-charged device, the target charging power of the monopulse antenna array in each preset tracking period may be determined based on the distance between the monopulse antenna array and the to-be-charged device that is tracked in each preset tracking period, and the monopulse antenna array is controlled, in the preset tracking period, to transmit the electromagnetic wave at the adjusted phase. Finally, the phase and power of the charging electromagnetic wave are adjusted simultaneously.

In other embodiments of this application, before the target charging power of the monopulse antenna array in each preset tracking period is determined based on the distance between the monopulse antenna array and the to-be-charged device that is tracked further includes:
determining, in each preset tracking period, whether the to-be-charged device is in a held state, and
that the target charging power of the monopulse antenna array in each preset tracking period is determined based on a distance between the monopulse antenna array and the to-be-charged device that is tracked in each preset tracking period includes:
determining, when the to-be-charged device is in the held state, the target charging power of the monopulse antenna array in the preset tracking period as first target charging power; or
determining, when the to-be-charged device is not in the held state, charging power of the monopulse antenna array in the preset tracking period as second target charging power, where
the first target charging power is less than the second target charging power.

In this embodiment, before the target charging power of the monopulse antenna array is determined in each preset tracking period, a built-in sensor of the to-be-charged device may be used to detect whether the to-be-charged device is in the held state in the preset tracking period, and report whether to-be-charged device is in the held state to a wireless charging apparatus. Therefore, the wireless charging apparatus adjusts the charging power based on whether the to-be-charged device is in the held state, to reduce adverse influences on users caused by excessive electromagnetic wave radiation during wireless charging.

For example, when the target charging power of the monopulse antenna array is determined in each preset tracking period, for a same preset tracking period, if it is detected that the to-be-charged device is not in the held state, the charging power is set as the second target charging power. If it is detected that the to-be-charged device is in the held state, the charging power is set as the first target charging power that is less than the second target charging power, to reduce impact of the electromagnetic radiation. In some alternative embodiments, for two preset tracking periods where the distances between the to-be-charged device and the pulse antenna array are the same, the charging power in the corresponding preset tracking period needs to be appropriately reduced when the to-be-charged device is in the held state, that is, the charging power is less than the charging power in the corresponding preset tracking period when the to-be-charged device is not in the held state, to reduce the impact of the electromagnetic radiation.

In other embodiments of this application, when detecting that the to-be-charged device is in a wireless charging range, the wireless charging apparatus may transmit information about wireless charging to the to-be-charged device. At this time, the to-be-charged device may response to the information, and pop up a charging selection button on a page. The users may click the charging selection button to manually set whether to perform wireless charging, set a charging mode, charging time, and the like.

Overall, in embodiments of this application, the position of the to-be-charged device is tracked by using the monopulse antenna array in the preset tracking period. Therefore, the power and/or the phase of the monopulse antenna array may be controlled based on the position of the to-be-charged device to wirelessly charge the to-be-charged device. A plurality of restrictions on the position, the distance, and the like of the to-be-charged device in an existing wireless charging technology are removed, and a wireless charging need of the to-be-charged device at the remote distance and in the moving scenario may be effectively satisfied. In addition, by determining whether the to-be-charged device is in the held state, the to-be-charged device is in the optimal charging state when charging safety is ensured.

Embodiments of this application provide a wireless charging method, and an execution entity may be a wireless charging apparatus. In embodiments of this application, that the wireless charging apparatus performs the wireless charging method is used as an example to explain the wireless charging apparatus provided by embodiments of this application.

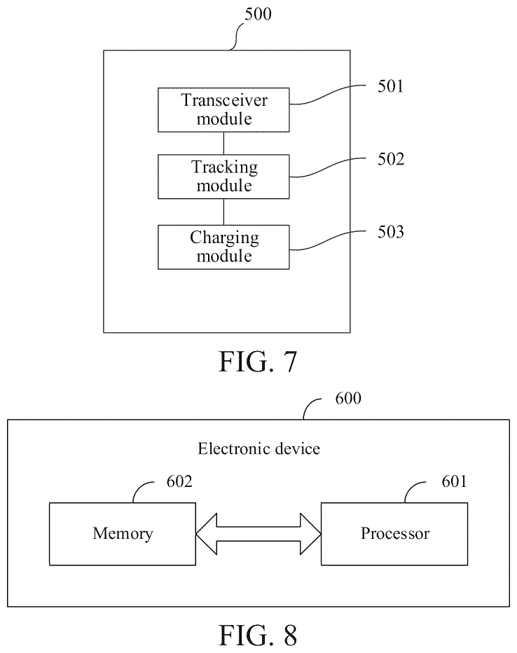

FIG. 7 is a schematic diagram of a structure of another wireless charging apparatus according to an embodiment of this application. As shown in FIG. 7, another aspect of embodiments of this application provides the wireless charging apparatus. The wireless charging apparatus 500 includes a monopulse antenna array, and the wireless charging apparatus 500 further includes:
a transceiver module 501, configured to: control, in a preset tracking period, the monopulse antenna array to transmit a sum beam and a difference beam to a to-be-charged device, and receive an echo signal reflected from the to-be-charged device, where the preset tracking period is a period that the monopulse antenna array transmits the sum beam and the difference beam;
a tracking module 502, configured to track a position of the to-be-charged device based on the echo signal; and
a charging module 503, configured to: control, based on position information of the to-be-charged device, the monopulse antenna array to wirelessly charge the to-be-charged device.

In some embodiments, the echo signal includes the difference signal, and the tracking module 502 includes:
a phase adjusting module, configured to adjust a phase of the monopulse antenna array based on the difference signal, to enable a zero value direction of the difference beam to be aligned with the to-be-charged device.

In some embodiments, the charging module 503 includes:
a first charging unit, configured to: control, in the preset tracking period, the monopulse antenna array to transmit an electromagnetic wave at an adjusted phase, to wirelessly charge the to-be-charged device.

In some embodiments, the echo signal further includes a sum signal, and the tracking module 502 further includes:
a distance determining unit, configured to determine a distance between the to-be-charged device and the monopulse antenna array based on the sum signal.

In some embodiments, the charging module 503 includes:
a determining unit, configured to: determine target charging power of the monopulse antenna array in each preset tracking period based on a distance between the monopulse antenna array and the to-be-charged device that is tracked in each preset tracking period; and
a second charging unit, configured to: control, in the preset tracking period, the monopulse antenna array to wirelessly charge the to-be-charged device at the target charging power.

In some embodiments, the wireless charging apparatus 500 further includes:
a determining module, configured to determine, in each preset tracking period, whether the to-be-charged device is in a held state, where
the determining unit includes:
a first sub-determining unit, configured to: determine, when the to-be-charged device is in the held state, target charging power of the monopulse antenna array in the preset tracking period as first target charging power; and
a second sub-determining unit, configured to: determine, when the to-be-charged device is not in the held state, charging power of the monopulse antenna array in the preset tracking period as second target charging power, where
the first target charging power is less than the second target charging power.

In embodiments of this application, a position of a to-be-charged device is tracked by using a monopulse antenna array in a preset tracking period. Therefore, power and/or a phase of the monopulse antenna array may be controlled based on the position of the to-be-charged device to wirelessly charge the to-be-charged device. A plurality of restrictions on the position, a distance, and the like of the to-be-charged device in an existing wireless charging technology are removed, and a wireless charging need of the to-be-charged device at a remote distance and in a moving scenario may be effectively satisfied.

The wireless charging apparatus in embodiments of this application may be an apparatus with an operating system. The operating system may be an Android operating system, an iOS operating system, or other possible operating systems, which is not specifically limited in the embodiments of this application.

The wireless charging apparatus provided by this embodiment of this application can realize each process realized by method embodiments of FIG. 1 to FIG. 6. To avoid repetition, this is not described herein again.

For example, as shown in FIG. 8, embodiments of this application further provide an electronic device 600, including a processor 601 and a memory 602. The memory 602 stores a program or instructions run on the processor 601. Each step of method embodiments for implementing the wireless charging method when the program or the instructions are executed by the processor 601, and a same technical effect can be achieved. To avoid repetition, this is not described herein again.

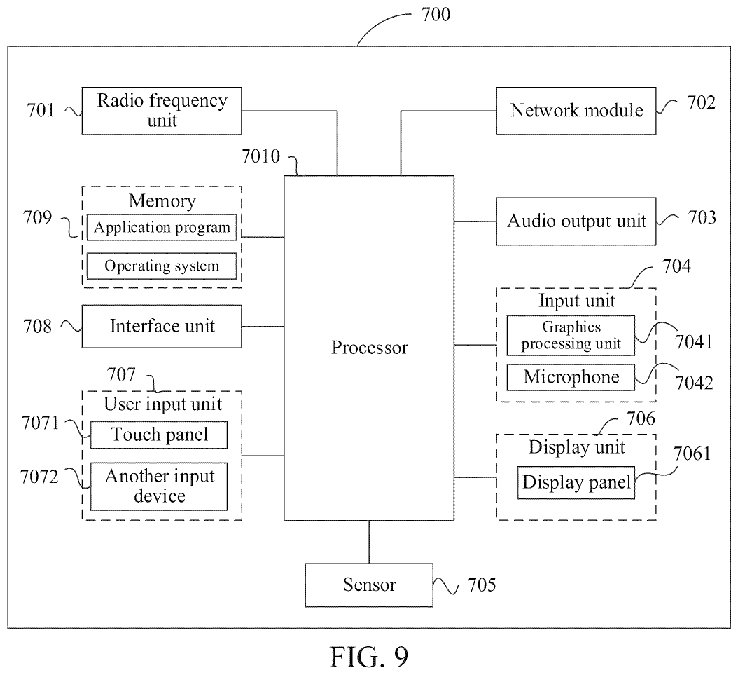

FIG. 9 is a schematic hardware diagram a structure of an electronic device for implementing an embodiment of this application.

An electronic device 700 includes, but is not limited to, components such as a radio frequency unit 701, a network module 702, an audio output unit 703, an input unit 704, a sensor 705, a display unit 706, a user input unit 707, an interface unit 708, a memory 709, and a processor 7010.

A person skilled in the art may understand that the electronic device 700 may further include the power supply (such as a battery) for supplying power to components. The power supply may be logically connected to the processor 7010 by a power management system, to implement functions such as charging, discharging, and power consumption management by using the power management system. The electronic device structure shown in FIG. 9 does not constitute a limitation on the electronic device, and the electronic device may include more or fewer components than shown, or combine some components, or have different component arrangements. This is not described herein again.

The radio frequency unit 701 includes a monopulse antenna array, and the radio frequency unit 701 is configured to: control, in a preset tracking period, the monopulse antenna array to transmit a sum beam and a difference beam to a to-be-charged device, and receive an echo signal reflected from the to-be-charged device, where the preset tracking period is a period that the monopulse antenna array transmits the sum beam and the difference beam.

The processor 7010 is configured to track a position of the to-be-charged device based on the echo signal.

The processor 7010 is further configured to: control, based on position information of the to-be-charged device, the monopulse antenna array to wirelessly charge the to-be-charged device.

In embodiments of this application, a position of a to-be-charged device is tracked by using a monopulse antenna array in a preset tracking period. Therefore, power and/or a phase of the monopulse antenna array may be controlled based on the position of the to-be-charged device to wirelessly charge the to-be-charged device. A plurality of restrictions on the position, a distance, and the like of the to-be-charged device in an existing wireless charging technology are removed, and a wireless charging need of the to-be-charged device at a remote distance and in a moving scenario may be effectively satisfied.

In some embodiments, the echo signal includes the difference signal, and the processor 7010 is further configured to adjust the phase of the monopulse antenna array based on the difference signal, to enable a zero value direction of the difference beam to be aligned with the to-be-charged device.

In some embodiments, the processor 7010 is further configured to: control the monopulse antenna array, in the preset tracking period, to transmit an electromagnetic wave at an adjusted phase, to wirelessly charge the to-be-charged device.

In some embodiments, the echo signal further includes a sum signal, and the processor 7010 is further configured to determine a distance between the to-be-charged device and the monopulse antenna array based on the sum signal.

In some embodiments, the processor 7010 is further configured to: determine target charging power of the monopulse antenna array in each preset tracking period based on a distance between the monopulse antenna array and the to-be-charged device that is tracked in each preset tracking period; and control, in the preset tracking period, the monopulse antenna array at the target charging power to wirelessly charge the to-be-charged device.

In some embodiments, the processor 7010 is further configured to: determine, in each preset tracking period, whether the to-be-charged device is in a held state.

The processor 7010 is further configured to: determine, when the to-be-charged device is in the held state, charging power of the monopulse antenna array in the preset tracking period as first target charging power; and
determine, when the to-be-charged device is not in the held state, charging power of the radio frequency unit 701 in the preset tracking period as second target charging power, where
the first target charging power is less than the second target charging power.

It should be understood that, the input unit 704 may include a Graphics Processing Unit (GPU) 7041 and a microphone 7042. The graphics processing unit 7041 performs processing on image data of a static picture or a video that is obtained by an image acquisition device (for example, a camera) in a video acquisition mode or an image acquisition mode. The display unit 706 may include a display panel 7061, and the display panel 7061 may be configured by using a liquid crystal display, an organic light-emitting diode, or the like. The user input unit 707 includes at least one of a touch panel 7071 and another input device 7072. The touch panel 7071 may also be referred to as a touchscreen. The touch panel 7071 may include two parts: a touch detection apparatus and a touch controller. The another input device 7072 may include, but is not limited to, a physical keyboard, a functional key (such as a volume control key or a switch key), a track ball, a mouse, and a joystick. This is not described herein again.

The memory 709 may be configured to store a software program and various data. The memory 709 may mainly include a first storage area that stores a program or instructions and a second storage area that stores data. The first storage area may store an operating system, an application program or the instructions required by at least one function (for example, a sound playback function and an image display function), and the like. In addition, the memory 709 may include a volatile memory or a non-volatile memory, or the memory 709 may include both a volatile memory and a non-volatile memory. The non-volatile memory may be a Read-Only Memory (ROM), a Programmable ROM (PROM), an Erasable PROM (EPROM), an Electrically EPROM (EEPROM) or a flash memory. The volatile memory may be a Random Access Memory (RAM), a Static RAM (SRAM), a Dynamic RAM (DRAM), a Synchronous DRAM (SDRAM), a Double Data Rate SDRAM (DDR_SDRAM), an Enhanced SDRAM (ESDRAM), a Synchlink DRAM (SLDRAM), and a Direct Rambus RAM (DRRAM). The memory 709 in this embodiment of this application includes, but is not limited to, the memories and any other memory of a suitable type.

The processor 7010 may include one or more processing units. In some embodiments, the processor 7010 may integrate an application processor and a modem processor. The application processor mainly processes an operation involving technologies operating system, a user interface, an application program, and the like. The modem processor mainly processes a wireless communication signal, such as a baseband processor. It may be understood that the foregoing modem may either not be integrated into the processor 7010.

An embodiment of this application further provides a readable storage medium, where the readable storage medium stores a program or instructions. Each process of the wireless charging method is implemented when the program or the instructions is/are executed by a processor, and a same technical effect can be achieved. To avoid repetition, this is not described herein again.

The processor may be a processor of the electronic device in the foregoing embodiments. The readable storage medium includes a computer-readable storage medium, for example, a computer read-only memory, a random access memory, magnetic disk, or optical disk.

An embodiment of this application further provides a chip. The chip includes a processor and a communication interface. The communication interface is coupled to the processor. The processor is used to run a program or instructions, to implement the wireless charging method, and a same technical effect can be achieved. To avoid repetition, this is not described herein again.

It should be understood that, the chip mentioned in this embodiment of this application further may be referred to as a system chip, a chip system, a system on chip, or the like.

Embodiments of this application provide a computer program product, where the program product is stored in a storage medium. The program product is executed by at least one processor each process of the wireless charging method, and a same technical effect can be achieved. To avoid repetition, this is not described herein again.

It should be noted that the terms “include”, “comprise”, or any other variation thereof in this specification is intended to cover a non-exclusive inclusion, which specifies the presence of stated processes, methods, objects, or apparatuses, but do not preclude the presence or addition of one or more other processes, methods, objects, or apparatuses. Without more limitations, elements defined by the sentence “including one . . . ” does not exclude that there are still other same elements in the processes, methods, objects, or apparatuses. In addition, it should be noted that, a range of the method and the apparatus in embodiments of this application is not limited to perform a function in a sequence shown or discussed, and may further include performing the function based on a related function in a substantially same manner or in a reverse sequence. For example, the function may be performed in the sequence shown or discussed. The described method may be performed in a sequence different from the described method, and various steps may be added, omitted, or combined. In addition, features described with reference to examples may be combined in other examples.

Through the descriptions of the foregoing implementations, a person skilled in the art may clearly understand that the methods in the foregoing embodiments may be implemented by using software and a necessary general hardware platform, or be implemented by hardware. In some embodiments, the technical solutions of this application entirely or the part contributing to the current art may be implemented in a form of a computer software product. The computer software product is stored in a storage medium (such as a ROM/RAM, a magnetic disk, or an optical disc) and includes several instructions for instructing a terminal (which may be a mobile phone, a computer, a server, a network device, or the like) to perform the methods described in embodiments of this application.

Embodiments of this application are described above with reference to the accompanying drawings. However, this application is not limited to the foregoing implementations. The foregoing implementations are illustrative instead of imitative. Enlightened by this application, a person of ordinary skill in the art can make many forms without departing from the idea of this application and the scope of protection of the claims. All of the forms fall within the protection of this application.

What is claimed is:

1. A wireless charging method, performed by a wireless charging apparatus comprising a monopulse antenna array, comprising:
controlling, in a preset tracking period, the monopulse antenna array to transmit a sum beam and a difference beam to a to-be-charged device, and receiving an echo signal reflected from the to-be-charged device, wherein the preset tracking period is a period that the monopulse antenna array transmits the sum beam and the difference beam;
tracking a position of the to-be-charged device based on the echo signal; and
controlling, based on position information of the to-be-charged device, the monopulse antenna array to wirelessly charge the to-be-charged device.

2. The wireless charging method according to claim 1, wherein the echo signal comprises a difference signal, and tracking the position of the to-be-charged device based on the echo signal comprises:
adjusting a phase of the monopulse antenna array based on the difference signal, to enable a zero value direction of the difference beam to be aligned with the to-be-charged device.

3. The wireless charging method according to claim 2, wherein controlling, based on the position information of the to-be-charged device, the monopulse antenna array to wirelessly charge the to-be-charged device comprises:
controlling, in the preset tracking period, the monopulse antenna array to transmit an electromagnetic wave at an adjusted phase, to wirelessly charge the to-be-charged device.

4. The wireless charging method according to claim 2, wherein the echo signal further comprises a sum signal, and tracking the position of the to-be-charged device based on the echo signal comprises:
determining a distance between the to-be-charged device and the monopulse antenna array based on the sum signal.

5. The wireless charging method according to claim 4, wherein controlling, based on the position information of the to-be-charged device, the monopulse antenna array to wirelessly charge the to-be-charged device further comprises:
determining target charging power of the monopulse antenna array in each preset tracking period based on a distance between the monopulse antenna array and the to-be-charged device that is tracked in each preset tracking period; and
controlling, in the preset tracking period, the monopulse antenna array to wirelessly charge the to-be-charged device at the target charging power.

6. The wireless charging method according to claim 5, wherein before determining the target charging power of the monopulse antenna array in each preset tracking period based on the distance between the monopulse antenna array and the to-be-charged device that is tracked, the method further comprises:
determining, in each preset tracking period, whether the to-be-charged device is in a held state; and
determining the target charging power of the monopulse antenna array in each preset tracking period based on the distance between the monopulse antenna array and the to-be-charged device that is tracked in each preset tracking period comprises:
determining, when the to-be-charged device is in the held state, charging power of the monopulse antenna array in the preset tracking period as first target charging power; or
determining, when the to-be-charged device is not in the held state, charging power of the monopulse antenna array in the preset tracking period as second target charging power, wherein
the first target charging power is less than the second target charging power.

7. An electronic device, comprising: a processor; and a memory having a computer program or an instruction stored thereon, wherein the computer program or the instruction, when executed by the processor, causes the processor to perform operations, comprising:
controlling, in a preset tracking period, a monopulse antenna array to transmit a sum beam and a difference beam to a to-be-charged device, and receiving an echo signal reflected from the to-be-charged device, wherein the preset tracking period is a period that the monopulse antenna array transmits the sum beam and the difference beam;
tracking a position of the to-be-charged device based on the echo signal; and
controlling, based on position information of the to-be-charged device, the monopulse antenna array to wirelessly charge the to-be-charged device.

8. The electronic device according to claim 7, wherein the echo signal comprises a difference signal, and tracking the position of the to-be-charged device based on the echo signal comprises:
adjusting a phase of the monopulse antenna array based on the difference signal, to enable a zero value direction of the difference beam to be aligned with the to-be-charged device.

9. The electronic device according to claim 8, wherein controlling, based on the position information of the to-be-charged device, the monopulse antenna array to wirelessly charge the to-be-charged device comprises:
controlling, in the preset tracking period, the monopulse antenna array to transmit an electromagnetic wave at an adjusted phase, to wirelessly charge the to-be-charged device.

10. The electronic device according to claim 8, wherein the echo signal further comprises a sum signal, and tracking the position of the to-be-charged device based on the echo signal comprises:
determining a distance between the to-be-charged device and the monopulse antenna array based on the sum signal.

11. The electronic device according to claim 10, wherein controlling, based on the position information of the to-be-charged device, the monopulse antenna array to wirelessly charge the to-be-charged device further comprises:
determining target charging power of the monopulse antenna array in each preset tracking period based on a distance between the monopulse antenna array and the to-be-charged device that is tracked in each preset tracking period; and
controlling, in the preset tracking period, the monopulse antenna array to wirelessly charge the to-be-charged device at the target charging power.

12. The electronic device according to claim 11, wherein before determining the target charging power of the monopulse antenna array in each preset tracking period based on the distance between the monopulse antenna array and the to-be-charged device that is tracked, the operations further comprise:
determining, in each preset tracking period, whether the to-be-charged device is in a held state; and
determining the target charging power of the monopulse antenna array in each preset tracking period based on the distance between the monopulse antenna array and the to-be-charged device that is tracked in each preset tracking period comprises:
determining, when the to-be-charged device is in the held state, charging power of the monopulse antenna array in the preset tracking period as first target charging power; or
determining, when the to-be-charged device is not in the held state, charging power of the monopulse antenna array in the preset tracking period as second target charging power, wherein
the first target charging power is less than the second target charging power.

13. A non-transitory computer-readable storage medium storing a computer program or an instruction that, when executed by a processor, causes the processor to perform operations comprising:
controlling, in a preset tracking period, a monopulse antenna array to transmit a sum beam and a difference beam to a to-be-charged device, and receiving an echo signal reflected from the to-be-charged device, wherein the preset tracking period is a period that the monopulse antenna array transmits the sum beam and the difference beam;
tracking a position of the to-be-charged device based on the echo signal; and
controlling, based on position information of the to-be-charged device, the monopulse antenna array to wirelessly charge the to-be-charged device.

14. The non-transitory computer-readable storage medium according to claim 13, wherein the echo signal comprises a difference signal, and tracking the position of the to-be-charged device based on the echo signal comprises:
adjusting a phase of the monopulse antenna array based on the difference signal, to enable a zero value direction of the difference beam to be aligned with the to-be-charged device.

15. The non-transitory computer-readable storage medium according to claim 14, wherein controlling, based on the position information of the to-be-charged device, the monopulse antenna array to wirelessly charge the to-be-charged device comprises:
controlling, in the preset tracking period, the monopulse antenna array to transmit an electromagnetic wave at an adjusted phase, to wirelessly charge the to-be-charged device.

16. The non-transitory computer-readable storage medium according to claim 14, wherein the echo signal further comprises a sum signal, and tracking the position of the to-be-charged device based on the echo signal comprises:
determining a distance between the to-be-charged device and the monopulse antenna array based on the sum signal.

17. The non-transitory computer-readable storage medium according to claim 16, wherein controlling, based on the position information of the to-be-charged device, the monopulse antenna array to wirelessly charge the to-be-charged device further comprises:
determining target charging power of the monopulse antenna array in each preset tracking period based on a distance between the monopulse antenna array and the to-be-charged device that is tracked in each preset tracking period; and
controlling, in the preset tracking period, the monopulse antenna array to wirelessly charge the to-be-charged device at the target charging power.

18. The non-transitory computer-readable storage medium according to claim 17, wherein before determining the target charging power of the monopulse antenna array in each preset tracking period based on the distance between the monopulse antenna array and the to-be-charged device that is tracked, the operations further comprise:
determining, in each preset tracking period, whether the to-be-charged device is in a held state; and
determining the target charging power of the monopulse antenna array in each preset tracking period based on the distance between the monopulse antenna array and the to-be-charged device that is tracked in each preset tracking period comprises:
determining, when the to-be-charged device is in the held state, charging power of the monopulse antenna array in the preset tracking period as first target charging power, or
determining, when the to-be-charged device is not in the held state, charging power of the monopulse antenna array in the preset tracking period as second target charging power, wherein
the first target charging power is less than the second target charging power
